(19) United States
(12) Patent Application Publication
(10) Pub. No.: US 2024/0234780 A1
(43) Pub. Date: Jul. 11, 2024

(54) STACK CARTRIDGE ASSEMBLY

(71) Applicant: HYUNDAI MOBIS CO., LTD., Seoul (KR)

(72) Inventor: Myeong Nam WOO, Yongin-si (KR)

(73) Assignee: HYUNDAI MOBIS CO., LTD., Seoul (KR)

(21) Appl. No.: 18/405,004

(22) Filed: Jan. 5, 2024

(30) Foreign Application Priority Data
Jan. 6, 2023 (KR) 10-2023-0002396

(51) Int. Cl. H01M 8/2475; H01M 8/0267; H01M 8/04664; H01M 8/1004; H01M 8/248; H01M 8/249

(52) U.S. Cl. CPC H01M 8/2475; H01M 8/0267; H01M 8/04671; H01M 8/1004; H01M 8/248; H01M 8/249

(57) ABSTRACT

A stack cartridge assembly is provided. The assembly includes a first stack cartridge and a second stack cartridge. The first stack cartridge includes first cells stacked along a reference direction, a (1-1)-th end plate disposed in the reference direction of the first cells, and a (1-2)-th end plate disposed on an opposite direction to the reference direction. The second stack cartridge includes second cells staked along the reference direction, a (2-1)-th end plate disposed in the reference direction of the second cells, and a (2-2)-th end plate disposed in the opposite direction. The (1-1)-th end plate and the (2-2)-th end plate have corresponding shapes.

### CROSS-REFERENCE TO RELATED APPLICATION

This application claims the benefit of priority to Korean Patent Application No. 10-2023-0002396, filed in the Korean Intellectual Property Office on Jan. 6, 2023, the entire contents of which are incorporated herein by reference.

### BACKGROUND

### 1. Field

The present disclosure relates to a stack cartridge assembly.

### 2. Description of Related Art

A fuel cell system is a system that continuously produces electric energy with a chemical reaction of a fuel that is continuously supplied, and has been continuously researched and developed as a measure for solving the global warning problem.

A hydrogen fuel cell system refers to a system that produces electric power by supplying hydrogen and oxygen to a stack by using a fuel processing system (FPS) and an air processing system (APS).

In a stack, generally, about 400 or more membrane electrode assemblies are stacked. Due to the structural characteristics of the stack, when a performance of a membrane electrode assembly at a portion thereof is degraded or an error occurs, the portion also deteriorates membrane electrode assemblies in surrounding sectors. That is, even when an error occurs at the portion, the entire stack may need to be replaced.

In a conventional hydrogen fuel cell system, because all of about 400 or more membrane electrode assemblies have to be discarded or replaced to remove several or several tens of membrane electrode assemblies that are degraded whereby loss costs become high.

### SUMMARY

The present disclosure has been made to solve the above-mentioned problems occurring in the prior art while advantages achieved by the prior art are maintained intact.

An aspect of the present disclosure provides a stack cartridge assembly, in which only a cartridge including a problematic membrane electrode assembly may be replaced.

The technical problems to be solved by the present disclosure are not limited to the aforementioned problems, and any other technical problems not mentioned herein will be clearly understood from the following description by those skilled in the art to which the present disclosure pertains.

In a general aspect of the disclosure a stack cartridge assembly includes a first stack cartridge and a second stack cartridge. The first stack cartridge includes first cells stacked along a reference direction, a (1-1)-th end plate disposed in the reference direction of the first cells, and a (1-2)-th end plate disposed on an opposite direction to the reference direction. The second stack cartridge includes second cells staked along the reference direction, a (2-1)-th end plate disposed in the reference direction of the second cells, and a (2-2)-th end plate disposed in the opposite direction. The (1-1)-th end plate and the (2-2)-th end plate have corresponding shapes.

The (1-1)-th end plate may include: a (1-1)-th hole passing along the reference direction; and a (1-2)-th hole passing along the reference direction, the (1-2)-th hole including a diameter which is larger than that of the (1-1)-th hole, wherein the (2-2)-th end plate includes: a (2-1)-th hole passing along the reference direction; and a (2-2)-th hole passing along the reference direction, and a diameter of which is larger than that of the (2-1)-th hole, wherein the (1-1)-th hole is in communication with the (2-1)-th hole, and wherein the (1-2)-th hole is in communication with the (2-2)-th hole.

The (1-1)-th end plate includes a (1-1)-th groove may be formed to surround the (1-1)-th hole and the (1-2)-th hole, the (1-1)-th end plate recessed along an opposite direction of the reference direction, wherein the (2-2)-th end plate includes a (2-1)-th groove formed to surround the (2-1)-th hole and the (2-2)-th hole, the (2-2)-th end plate recessed along the reference direction, and wherein the stack cartridge assembly further comprises a first sealing member inserted into the (1-1)-th groove and the (2-1)-th groove, the first sealing member configured to maintain a sealing state between the (1-1)-th end plate and the (2-2)-th end plate.

A first boss protruding along the reference direction may be formed on an outer surface of the (1-1)-th groove in the (1-1)-th end plate.

The (1-1)-th end plate may include: a (1-3)-th hole passing along the reference direction; and a (1-4)-th hole passing along the reference direction, the (1-4)-th hole including a diameter which is smaller than that of the (1-3)-th hole, wherein (2-2)-th end plate includes: a (2-3)-th hole passing along the reference direction; and a (2-4)-th hole passing along the reference direction, and a diameter of which is smaller than that of the (2-3)-th hole, wherein the (1-3)-th hole is in communication with the (2-3)-th hole, and wherein the (1-4)-th hole is in communication with the (2-4)-th hole.

The diameter of the (1-1)-th hole may correspond to the diameter of the (1-4)-th hole, and the diameter of the (1-2)-th hole may correspond to the diameter of the (1-3)-th hole.

When a direction facing the (1-2)-th hole from the (1-1)-th hole is defined as a first direction and a direction facing the (1-3)-th hole from the (1-1)-th hole is defined as a second direction, the first direction and the second direction may be perpendicular to each other.

A (1-1)-th fastening recess recessed along the opposite direction of the reference direction may be formed at a portion of a periphery of the (1-1)-th end plate, wherein a (1-2)-th fastening recess recessed along the reference direction is formed at a portion of a periphery of the (1-2)-th end plate, which corresponds to the (1-1)-th fastening recess, and wherein the first stack cartridge further includes: a first pressing member including opposite ends that are inserted into the (1-1)-th fastening recess and the (1-2)-th fastening recess to press the (1-1)-th end plate and the (1-2)-th end plate.

A (2-1)-th fastening recess recessed along the opposite direction of the reference direction may be formed at a portion of a periphery of the (2-1)-th end plate, wherein a (2-2)-th fastening recess recessed along the reference direction is formed at a portion of a periphery of the (2-2)-th end plate, which corresponds to the (2-1)-th fastening recess, wherein the second stack cartridge further includes: a second pressing member including opposite ends of which are inserted into the (2-1)-th fastening recess and the (2-2)-th fastening recess to press the (2-1)-th end plate and the (2-2)-th end plate, and wherein the stack cartridge assembly further comprises a connection member connecting the first pressing member and the second pressing member.

When, among two directions, in which the (1-1)-th fastening recess is opened, a direction other than the reference direction may be defined as a protrusion direction, wherein the first pressing member includes: a (1-1)-th part configured to be inserted into the (1-1)-th fastening recess and having a (1-1)-th area protruding in the protrusion direction; a (1-2)-th part configured to be inserted into the (1-2)-th fastening recess and having a (1-2)-th area protruding in the protrusion direction; and a (1-3)-th part connecting the (1-1)-th part and the (1-2)-th part.

The second pressing member may include: a (2-1)-th part configured to be inserted into the (2-1)-th fastening recess, and having a (2-1)-th area protruding in the protrusion direction; a (2-2)-th part configured to be inserted into the (2-1)-th fastening recess, and having a (2-2)-th area protruding in the protrusion direction; and a (2-3)-th part connecting the (2-1)-th part and the (2-2)-th part, and wherein the (1-1)-th part and the (2-2)-th part are spaced apart from each other along the reference direction.

A length of the (1-1)-th part along the reference direction may correspond to a length of the (1-1)-th fastening recess along the reference direction.

The (1-2)-th end plate may include: a fuel electrode introduction hole formed at a location corresponding to the (1-1)-th hole, the fuel electrode introduction hole including a diameter which corresponds to that of the (1-1)-th hole; and an air electrode introduction hole formed at a location corresponding to the (1-2)-th hole, the air electrode introduction hole including a diameter which corresponds to that of the (1-2)-th hole.

The stack cartridge assembly may further include: a first cooling hole passing along the reference direction and disposed between the (1-1)-th hole and the (1-2)-th hole, the first cooling hole formed in the (1-1)-th end plate; and a second cooling hole passing along the reference direction and disposed between the (2-1)-th hole and the (2-2)-th hole, the second cooling hole formed is formed in the (2-2)-th end plate.

The stack cartridge assembly may further include: a cooling fluid hole formed at a location correspond to the second cooling hole, the cooling fluid hole including a shape which corresponds to that of the second cooling hole, wherein the cooling fluid hole is formed in the (2-1)-th end plate.

The stack cartridge assembly may further include: a third stack cartridge including a plurality of third cells stacked along the reference direction; a (3-1)-th end plate disposed in the reference direction of the third cells; and a (3-2)-th end plate disposed on the opposite direction of the reference direction, and disposed between the first stack cartridge and the second stack cartridge, wherein the (1-1)-th end plate and the (3-2)-th end plate have corresponding shapes, and wherein the (2-2)-th end plate and the (3-1)-th end plate have corresponding shapes.

Each of the first stack cartridge and the second stack cartridge may include a plurality of membrane electrode assemblies, wherein the stack cartridge assembly may further include: a processor configured to: detect malfunction among the plurality of membrane electrode assemblies in at least one of the first stack cartridge and the second stack cartridge; and upon a detection of malfunction, provide an alert of the detection to replace the stack cartridge containing the malfunctioning membrane electrode assembly.

In another general aspect of the disclosure, a stack cartridge assembly includes a first stack cartridge and a second stack cartridge. The first stack cartridge includes: a plurality of first cells stacked along the reference direction; a (1-1)-th end plate disposed in a reference direction of the first cells; a (1-2)-th end plate disposed in an opposite direction to the reference direction; and a first pressing member configured to press the (1-1)-th end plate and the (1-2)-th end plate such that the (1-1)-th end plate and the (1-2)-th end plate press each other. The second stack cartridge includes: a plurality of second cells stacked along the reference direction; a (2-1)-th end plate disposed in the reference direction of the second cells; a (2-2)-th end plate disposed in the opposite direction to the reference direction; and a second pressing member configured to press the (2-1)-th end plate and the (2-2)-th end plate such that the (2-1)-th end plate and the (2-2)-th end plate press each other; and a connection member connecting the first pressing member and the second pressing member.

### BRIEF DESCRIPTION OF THE DRAWINGS

The above and other objects, features and advantages of the present disclosure will be more apparent from the following detailed description taken in conjunction with the accompanying drawings:

FIG. 1 is a view conceptually illustrating a stack cartridge assembly according to an embodiment of the present disclosure;

FIG. 2 conceptually illustrates a stack cartridge assembly including three stack cartridges;

FIG. 3 is a perspective view illustrating a first stack cartridge;

FIG. 4 is an enlarged view of a double-dot chain line area of FIG. 3.

FIG. 5 is a perspective view of a first stack cartridge, viewed from another direction;

FIG. 6 is a perspective view illustrating a second stack cartridge;

FIG. 7 is a view illustrating a state, in which a first sealing member is disposed in FIG. 4;

FIG. 8 is a view illustrating a first pressing member; and

FIG. 9 is a view illustrating a state, in which a first pressing member and a second pressing member are connected to each other by a connection member.

### DETAILED DESCRIPTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

In the specification, a forward/rearward direction, a leftward/rightward direction, and an upward/downward direction are referred for convenience of description, and they may be directions that are perpendicular to each other. However, the directions are determined relative to a direction, in which lamps are arranged, and the upward/downward direction does not necessarily mean a vertical direction.

A stack cartridge assembly according to an embodiment of the present disclosure may be an assembly of cartridges each including a stack used for a fuel cell system. The stack may have various structures that may produce electricity through an oxidation/reduction reaction of a fuel and an oxidizer. The fuel may be hydrogen. The oxidizer may be oxygen.

The stack may include a plurality of cells. The cell may include a membrane electrode assembly (not illustrated), in which catalytic electrode layers for electrochemical reactions are attached to opposite sides of an electrolyte membrane, through which protons travel, a gas diffusion layer (not illustrated) that uniformly distributes reaction gases and functions to deliver generated electric energy, and a bipolar plate, through which the reaction gases and a cooling fluid flow.

In more detail, hydrogen that is a fuel and oxygen that is an oxidizer are supplied from the stack to an anode and a cathode of the membrane electrode assembly through passages of the bipolar plate, respectively, and the hydrogen may be supplied to the anode and the air may be supplied to the cathode, respectively.

The hydrogen supplied to the anode is decomposed into protons and electrons by a catalyst of electrode layers disposed on opposite sides of the electrolyte membrane, and among them, only the protons may selectively pass through the electrolyte membrane that is a proton exchange membrane and are delivered to the cathode and the electrons may be delivered to the cathode through a gas diffusion layer and a bipolar plate, which are conductors.

In the cathode, the protons supplied through the electrolyte membrane and the electrons delivered through the bipolar plate may meet oxygen in the air supplied to the cathode by an air supply device to cause a reaction that generates water. Due to the travel of the protons that are generated then, the electrons flow through an external wire, and electric currents may be generated due to the flows of the electrons.

The present disclosure relates to a stack cartridge assembly, in which only a cartridge including a problematic membrane electrode assembly may be replaced. Hereinafter, a detailed structure of the stack cartridge assembly, in which only a cartridge including a problematic membrane electrode assembly may be replaced, will be described in detail.

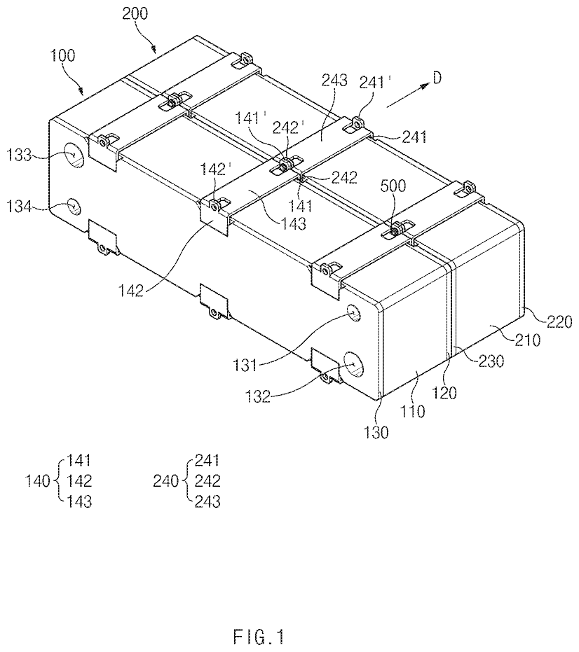

FIG. 1 is a view conceptually illustrating a stack cartridge assembly according to an embodiment of the present disclosure. The stack cartridge assembly according to an embodiment of the present disclosure may include a first stack cartridge 100 and a second stack cartridge 200. However, the number of cartridges may not be limited in a range of two or more.

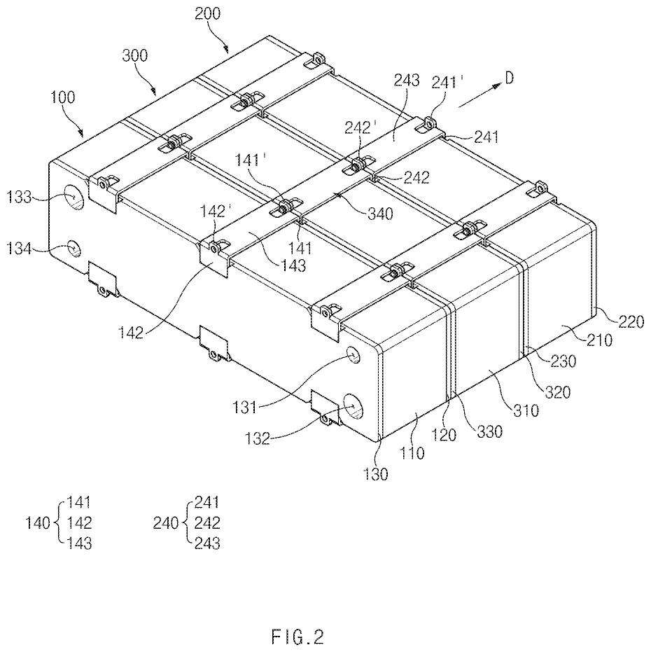

FIG. 2 conceptually illustrates the stack cartridge assembly including three stack cartridges. As illustrated in FIG. 2, the stack cartridge assembly may further include a third stack cartridge 300. The third stack cartridge 300 may be disposed between the first stack cartridge 100 and the second stack cartridge 200. Even when the number of stack cartridges increases, the first stack cartridge 100 and the second stack cartridge 200 may be disposed on opposite sides.

The first stack cartridge 100 may include a first cell 110, a (1-1)-th end plate 120, and a (1-2)-th end plate 130. The number of first cells 110 may be plural. The first cells 110 may be stacked along a reference direction “D”. For reference, for convenience of description, the drawing illustrates the first cells 110 as if the plurality of stacked first cells 110 are integrally formed. The (1-1)-th end plate 120 may be disposed in the reference direction “D” of the first cells 110. The (1-2)-th end plate 130 may be disposed in an opposite direction to the (1-1)-th end plate 120.

The second stack cartridge 200 may include second cells 210, a (2-1)-th end plate 220, and a (2-2)-th end plate 230. The number of second cells 210 may be plural. The second cells 210 may be stacked along the reference direction “D”. The (2-1)-th end plate 220 may be disposed in the reference direction “D” of the second cells 210. The (2-2)-th end plate 230 may be disposed in an opposite direction to the (2-1)-th end plate 220. The (1-1)-th end plate 120 and the (2-2)-th end plate 230 may have corresponding shapes.

According to the present disclosure, because the stack cartridge assembly includes the plurality of stack cartridges, only the problematic stack cartridge may be replaced when a problem occurs in some cartridges whereby repair costs may be reduced later.

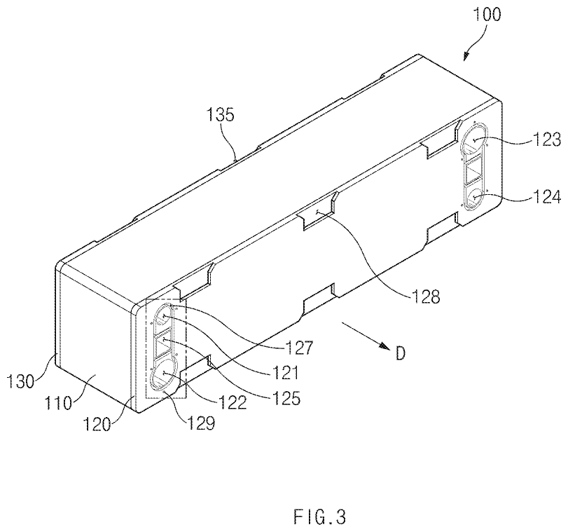

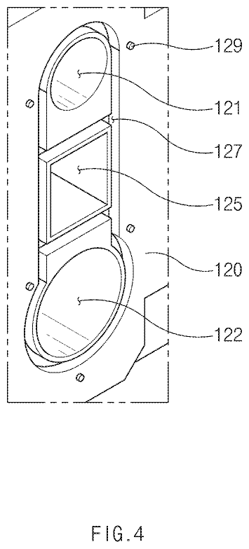

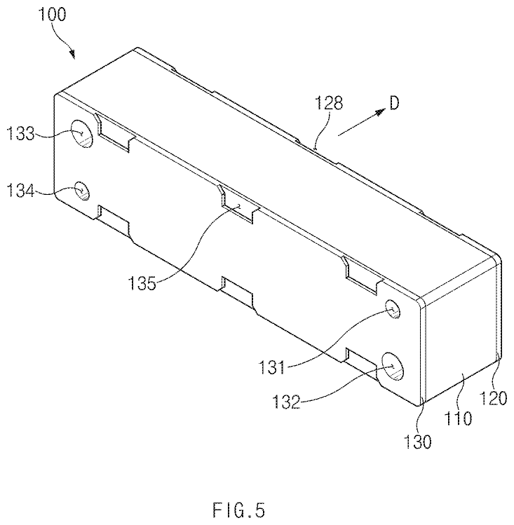

FIG. 3 is a perspective view illustrating a first stack cartridge. FIG. 4 is an enlarged view of a double-dot chain line area of FIG. 3. FIG. 5 is a perspective view of the first stack cartridge, viewed from another direction.

The end plate 120 may have a (1-1)-th hole 121 and a (1-2)-th hole 122. The (1-1)-th hole 121 may be a hole that passes along the reference direction “D”. The (1-2)-th hole 122 may be a hole that passes along the reference direction “D”, and a diameter of which is larger than a diameter of the (1-1)-th hole 121. The (1-1)-th hole 121 may be a hole, through which hydrogen is introduced. The (1-2)-th hole 122 may a hole, through which oxygen is introduced.

Furthermore, the (1-1)-th end plate 120 may have a (1-3)-th hole 123 and a (1-4)-th hole 124. The (1-3)-th hole 123 may be a hole that passes along the reference direction “D”. The (1-4)-th hole 124 may be a hole that passes in the reference direction “D”, and a diameter of which is smaller than a diameter of the (1-3)-th hole 123. The (1-3)-th hole 123 may be a hole, through which the oxygen is discharged. The (1-4)-th hole 124 may be a hole, through which the hydrogen is introduced. The diameter of the (1-1)-th hole 121 may correspond to the diameter of the diameter of the (1-4)-th hole 124, and the diameter of the (1-2)-th hole 122 may correspond to the (1-3)-th hole 123.

Meanwhile, when a direction that faces the (1-2)-th hole 122 from the (1-1)-th hole 121 is a first direction and a direction that faces the (1-3)-th hole 123 from the (1-1)-th hole 121 is a second direction, the first direction and the second direction may be perpendicular to each other.

Furthermore, the (1-1)-th end plate 120 may have a first cooling hole 125. The first cooling hole 125 may pass along the reference direction “D”, and may be disposed between the (1-1)-th hole 121 and the (1-2)-th hole 122. The (2-2)-th end plate 230 may have a second cooling hole. The second cooling hole may pass along the reference direction “D” at a location corresponding to the first cooling hole 125. The second cooling hole may be disposed between a (2-1)-th hole and a (2-2)-th hole. The first cooling hole 125 and the second cooling hole may be holes, through which the cooling fluid passes.

The end plate 130 may have a fuel electrode introduction hole 131. The fuel electrode introduction hole 131 may be formed at a location corresponding to the (1-1)-th hole 121, and a diameter thereof may correspond to the (1-1)-th hole 121. The hydrogen may be introduced into an interior of the stack cartridge assembly through the fuel electrode introduction hole 131.

The end plate 130 may have an air electrode introduction hole 132. The air electrode introduction hole 132 may be formed at a location corresponding to the (1-2)-th hole 122. A diameter of the air electrode introduction hole 132 may correspond to that of the (1-2)-th hole 122. The oxygen may be introduced into the interior of the stack cartridge assembly through the air electrode introduction hole 132.

The (1-2)-th end plate 130 may have an air electrode discharge hole 133. The air electrode discharge hole 133 may be formed at a location corresponding to the (1-3)-th hole 123, and a diameter thereof may correspond to that of the (1-3)-th hole 123. The oxygen may be discharged to an outside of the stack cartridge assembly through the air electrode discharge hole 133.

The (1-2)-th end plate 130 may have a fuel electrode discharge hole 134. The fuel electrode discharge hole 134 may be formed at a location corresponding to the (1-4)-th hole 124, and a diameter thereof may correspond to that of the (1-4)-th hole 124. The hydrogen may be discharged to the interior of the stack cartridge assembly through the fuel electrode discharge hole 134.

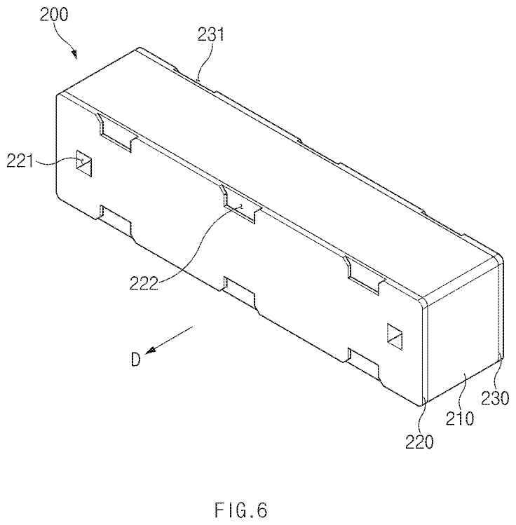

FIG. 6 is a perspective view illustrating a second stack cartridge. The (2-1)-th end plate 220 may have a cooling fluid hole 221. The cooling fluid hole 221 may be formed at a location corresponding to the second cooling hole, and a shape thereof may correspond to that of the second cooling hole. The cooling fluid hole 221 may be a hole, through which the cooling fluid is introduced or discharged.

The (2-2)-th end plate 230, as described above, has a shape corresponding to that of the (1-1)-th end plate, and thus, FIG. 5 may be referenced for a detailed shape thereof.

The (2-2)-th end plate 230 may have the (2-1)-th hole and the (2-2)-th hole. The (2-1)-th hole may be a hole that passes along the reference direction “D”. The (2-2)-th hole may be a hole that passes along the reference direction “D”, and a diameter of which is larger than that of the (2-1)-th hole. The (1-1)-th hole 121 may be communicated with the (2-1)-th hole. The (1-2)-th hole 122 may be communicated with the (2-2)-th hole.

Furthermore, the (2-2)-th end plate 230 may have a (2-3)-th hole and a (2-4)-th hole. The (2-3)-th hole may be a hole that passes along the reference direction “D”. The (2-4)-th hole may be a hole that passes along the reference direction “D”, and a diameter of which is smaller than that of the (2-3)-th hole. The (1-3)-th hole 123 may be communicated with the (2-3)-th hole, and the (1-4)-th hole 124 may be communicated with the (2-4)-th hole.

As in FIG. 2, when three stack cartridges are formed, the third stack cartridge 300 may include a plurality of third cells 310 that are stacked along the reference direction “D”, a (3-1)-th end plate 320 that is disposed in the reference direction “D” of the third cells 310, and a (3-2)-th end plate 330 that is disposed in an opposite direction to the reference direction “D”. Then, the (1-1)-th end plate 120 and the (3-2)-th end plate 330 may have corresponding shapes, and the (2-2)-th end plate 230 and the (3-1)-th end plate 320 may have corresponding shapes. Furthermore, the third stack cartridge 300 may include a third pressing member 340 corresponding to a first pressing member 140 and a second pressing member 240, which will be described below.

Meanwhile, when sealing is not secured between the stack cartridges, the hydrogen introduced into the (1-1)-th hole 121 or the oxygen introduced into the (1-2)-th hole 122 may not be introduced into the (2-1)-th hole and the (2-2)-th hole but may be partially leaked. Furthermore, the oxygen discharged through the (2-3)-th hole and the hydrogen discharged through the (2-4)-th hole may not be introduced into the (1-3)-th hole 123 and the (1-4)-th hole 124, but may be partially leaked. Hereinafter, a structure for maintaining a sealing state between the stack cartridge will be described in detail.

The end plate 120 may have a (1-1)-th groove 127. The (1-1)-th groove 127 may be formed to surround the (1-1)-th hole 121 and the (1-2)-th hole 122, and may be formed to be recessed along the reference direction “D”.

The (2-2)-th end plate 230 may have the (2-1)-th groove. The (2-1)-th groove may be formed to surround the (2-1)-th hole and the (2-2)-th hole, and may be formed to be recessed along the reference direction “D”.

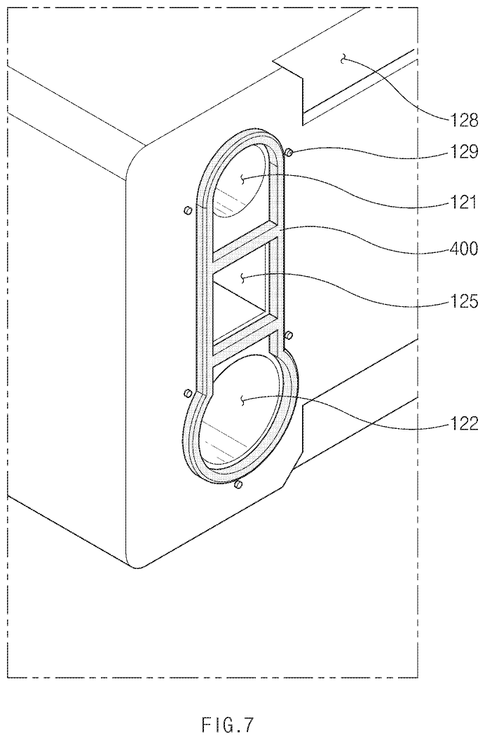

FIG. 7 is a view illustrating a state, in which the first sealing member is disposed.

The stack cartridge assembly according to an embodiment of the present disclosure may further include a first sealing member 400. The first sealing member 400 may be inserted into the (1-1)-th groove 127 and the (2-1)-th groove. This may mean that a half of the first sealing member 400 is inserted into the (1-1)-th groove 127 and the other half of the first sealing member 400 is inserted into the (2-1)-th groove when the first sealing member 400 is cut by a cross-section that is perpendicular to the reference direction “D”. The first sealing member 400 may be configured to maintain a sealing state between the (1-1)-th end plate 120 and the (2-2)-th end plate 230. In detail, the first sealing member 400 may be a structure that maintains a sealing state between the (1-1)-th hole 121 and the (2-1)-th hole and a sealing state between the (1-2)-th hole and the (2-2)-th hole.

Meanwhile, the stack cartridge assembly according to an embodiment of the present disclosure may further include a second sealing member.

The end plate 120 may have the (1-2)-th hole. A (1-2)-th groove may be formed to surround the (1-3)-th hole 123 and the (1-4)-th hole 124, and may be formed to be recessed along the opposite direction to the reference direction “D”.

The (2-2)-th end plate 230 may have a (2-2)-th groove. The (2-2)-th groove may be formed to surround the (2-3)-th hole and the (2-4)-th hole, and may be formed to be recessed along the reference direction “D”.

The (1-1)-th groove 127 and the (1-2)-th groove may be formed to be point-symmetrical to each other with respect to a central point of the end plate 120. Furthermore, the (2-1)-th groove and the (2-2)-th groove may be formed to be symmetrical to each other with respect to the (2-2)-th end plate 230.

The sealing member may be inserted into the (1-2)-th groove and the (2-2)-th groove. This may mean that a half of the second sealing member is inserted into the (1-2)-th groove and the other half of the second sealing member is inserted into the (2-2)-th groove when the second sealing member is cut by a cross-section that is perpendicular to the reference direction “D”. The second sealing member may be configured to maintain a sealing state between the (1-1)-th end plate 120 and the (2-2)-th end plate 230. In detail, the second sealing member may mean a structure that maintains a sealing state between the (2-3)-th hole and the (1-3)-th hole 123 and a sealing state between the (2-4)-th hole and the (1-4)-th hole 124.

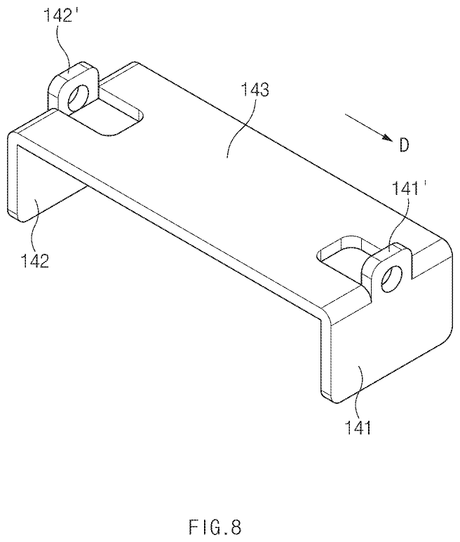

FIG. 8 is a view illustrating the first pressing member. The present disclosure has a structure, in which the end plates may be fastened to each other while a bolt or the like is not used. Hereinafter, the structure, in which the end plates may be fastened to each other while a bolt or the like is not used, will be described in detail.

A (1-1)-th fastening recess 128 may be formed at a portion of a periphery of the end plate 120. The (1-1)-th fastening recess 128 may be formed to be recessed along the opposite direction to the reference direction “D”. A (1-2)-th fastening recess 135 may be a recess that is formed at a portion of a periphery of the (1-2)-th end plate 130, which corresponds to the (1-1)-th fastening recess 128. The (1-2)-th fastening recess 135 may be formed to be recessed along the reference direction “D”.

The first stack cartridge 100 may further include the first pressing member 140. The first pressing member 140 may be a member, opposite ends of which are inserted into the (1-1)-th fastening recess 128 and the (1-2)-th fastening recess 135 to press the (1-1)-th end plate 120 and the (1-1)-th end plate 130. This may mean that the first pressing member 140 presses the (1-1)-th end plate 120 in the opposite direction to the reference direction “D” and presses the (1-2)-th end plate 130 in the reference direction “D”.

The first pressing member 140 may be a tension bar. The first pressing member 140 may press the (1-1)-th end plate 120 and the (1-2)-th end plate 130 through an elastic force. Accordingly, the (1-1)-th end plate 120 and the (1-2)-th end plate 130 may be connected to each other without no separate member, such as a bolt.

A (2-1)-th fastening recess 222 may be formed at a portion of a periphery of the end plate 220. The (2-1)-th fastening recess 222 may be formed to be recessed along the opposite direction to the reference direction “D”.

A (2-2)-th fastening recess 231 may be formed at a portion of the periphery of the end plate 230, which corresponds to the (2-1)-th fastening recess 222. The (2-2)-th fastening recess 231 may be formed to be recessed along the reference direction “D”.

The stack cartridge 200 may further include the second pressing member 240. Opposite ends of the second pressing member 240 may be inserted into the (2-1)-th fastening recess 222 and the (2-2)-th fastening recess 231 to press the (2-1)-th end plate 220 and the (2-2)-th end plate 230. This may mean that the second pressing member 240 presses the (2-1)-th end plate 220 in the opposite direction to the reference direction “D” and presses the (2-2)-th end plate 230 in the reference direction “D”.

The second pressing member 240 may be a tension bar. The second pressing member 240 may press the (2-1)-th end plate 220 and the (2-2)-th end plate 230 through an elastic force.

The first pressing member 140 and the second pressing member 240 may have corresponding shapes.

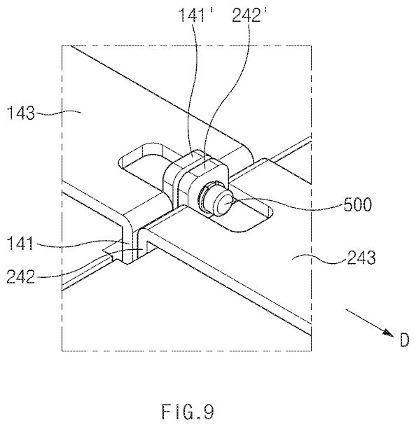

FIG. 9 is a view illustrating a state, in which the first pressing member and the second pressing member are connected to each other by the connection member. The first pressing member 140 and the second pressing member 240 may be connected to each other. As an example, the stack cartridge assembly according to an embodiment of the present disclosure may further include a connection member 500. The connection member 500 may be a member that connects the first pressing member 140 and the second pressing member 240. As an example, the connection member 500 may have a structure, in which a pin and a “C”-ring are coupled to each other. As another example, the connection member 500 may correspond to a bolt and a nut.

Hereinafter, a detailed structure for connecting the first pressing member 140 and the second pressing member 240 will be described in detail. Hereinafter, among the two directions, in which the (1-1)-th fastening recess 128 is opened, a direction except for the reference direction “D” will be referred to as a protrusion direction. This may be understood as a direction that faces an outside of the (1-1)-th end plate 120.

The first pressing member 140 may include a (1-1)-th part 141, a (1-2)-th part 142, and a (1-3)-th part 143. The (1-1)-th part 141 may be configured to be inserted into the (1-1)-th fastening recess 128. A length of the (1-1)-th part 141 along the reference direction “D” may correspond to a length of the (1-1)-th fastening recess 128 along the reference direction “D”. The (1-1)-th part 141 may have a (1-1)-th area 141′ that protrudes in the protrusion direction. The (1-1)-th area 141′ may be an area, to which the connection member 500 is fastened.

The (1-2)-th part 142 may be configured to be inserted into the (1-2)-th fastening recess 135. A length of the (1-2)-th part 142 along the reference direction “D” may correspond to a length of the (1-2)-th fastening recess 135 along the reference direction “D”. The (1-2)-th part 142 may have a (1-2)-th area 142′ that protrudes in the protrusion direction. The (1-2)-th part 142 may be an area, to which the connection member 500 may be fastened. The (1-2)-th area 142′ may be an area, to which the connection member 500 is fastened.

The (1-3)-th part 143 may connect the (1-1)-th part 141 and the (1-2)-th part 142.

The pressing member 240 may include a (2-1)-th part 241, a (2-2)-th part 242, and a (2-3)-th part 243. The (2-1)-th part 241 may be configured to be inserted into the (2-1)-th fastening recess 222. A length of the (2-1)-th part 241 along the reference direction “D” may correspond to a length of the (2-1)-th fastening recess 222 along the reference direction “D”. The (2-1)-th part 241 may have a (2-1)-th area 241′ that protrudes in the protrusion direction. The (2-1)-th area 241′ may be an area, to which the connection member 500 is fastened.

The (2-2)-th part 242 may be configured to be inserted into the (2-2)-th fastening recess 231. A length of the (2-2)-th part 242 along the reference direction “D” may correspond to a length of the (2-2)-th fastening recess 231 along the reference direction “D”. The (2-2)-th part 242 may have a (2-2)-th area 242′ that protrudes in the protrusion direction. The (2-2)-th area 242′ may be an area, to which the connection member 500 is fastened. As an example, the (1-1)-th area 141′ and the (2-2)-th area 242′ may be connected to each other through the connection member 500.

The (2-3)-th part 243 may connect the (2-1)-th part 241 and the (2-2)-th part 242.

The (1-1)-th part 141 and the (2-2)-th part 242 may be spaced apart from each other along the reference direction “D”. Because the (1-1)-th part 141 and the (2-2)-th part 242 are spaced apart from each other along the reference direction “D”, a displacement that occurs some vibrations in the fuel cell system may be absorbed.

Meanwhile, a first boss 129 that protrudes along the reference direction “D” may be formed on an outside of the (1-1)-th groove 127 of the (1-1)-th end plate 120. A plurality of first bosses 129 may be formed. The first boss 129 may have a structure for preventing leakage of hydrogen, oxygen, and the cooling fluid, which may occur due to leaning thereof to one side when the first stack cartridge 100 and the second stack cartridge 200 are connected to each other by the connection member 500.

According to the present disclosure, later repair costs may be minimized as only the cartridge including a problematic membrane electrode assembly is replaced when a portion of a stack has a problem by forming the stack in a form of a block with several cartridges.

The stack cartridge assembly may further include a controller (not shown), e.g., a processor, that is configured to detect malfunction among the membrane electrode assemblies in each of the stack cartridges of the stack cartridge assembly, and upon detection of a malfunction, provide an alert of the detection (e.g., to a service provider or user) to replace the stack cartridge containing the malfunctioning membrane electrode assembly. The controller may be located outside of the stack cartridge assembly and in communication with the stack cartridge assembly such that malfunction among the membrane electrode assemblies may be detected. As a non-limiting example, the controller may compare energy capacities of individual stack cartridges with predetermined values, and based on a variation above preset level or levels, determine that a malfunction in a particular stack cartridge exists.

Although the present disclosure has been described with reference to the limited embodiments and the drawings in the above description, the above description is simply an exemplary description of the technical spirits of the present disclosure, and an ordinary person in the art, to which the present disclosure pertains, may made various corrections and modifications without departing from the essential characteristics of the present disclosure. Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A stack cartridge assembly comprising:
a first stack cartridge including:
first cells stacked along a reference direction;
a (1-1)-th end plate disposed in the reference direction of the first cells; and
a (1-2)-th end plate disposed on an opposite direction to the reference direction; and
a second stack cartridge including:
second cells staked along the reference direction;
a (2-1)-th end plate disposed in the reference direction of the second cells; and
a (2-2)-th end plate disposed in the opposite direction,
wherein the (1-1)-th end plate and the (2-2)-th end plate have corresponding shapes.

2. The stack cartridge assembly of claim 1,
wherein the (1-1)-th end plate comprises:
a (1-1)-th hole passing along the reference direction; and
a (1-2)-th hole passing along the reference direction, the (1-2)-th hole including a diameter which is larger than that of the (1-1)-th hole,
wherein the (2-2)-th end plate comprises:
a (2-1)-th hole passing along the reference direction; and
a (2-2)-th hole passing along the reference direction, and a diameter of which is larger than that of the (2-1)-th hole,
wherein the (1-1)-th hole is in communication with the (2-1)-th hole, and
wherein the (1-2)-th hole is in communication with the (2-2)-th hole.

3. The stack cartridge assembly of claim 2,
wherein the (1-1)-th end plate includes a (1-1)-th groove formed to surround the (1-1)-th hole and the (1-2)-th hole, the (1-1)-th end plate recessed along an opposite direction of the reference direction,
wherein the (2-2)-th end plate includes a (2-1)-th groove formed to surround the (2-1)-th hole and the (2-2)-th hole, the (2-2)-th end plate recessed along the reference direction, and
wherein the stack cartridge assembly further comprises a first sealing member inserted into the (1-1)-th groove and the (2-1)-th groove, the first sealing member configured to maintain a sealing state between the (1-1)-th end plate and the (2-2)-th end plate.

4. The stack cartridge assembly of claim 3, wherein a first boss protruding along the reference direction is formed on an outer surface of the (1-1)-th groove in the (1-1)-th end plate.

5. The stack cartridge assembly of claim 2,
wherein the (1-1)-th end plate includes:
a (1-3)-th hole passing along the reference direction; and
a (1-4)-th hole passing along the reference direction, the (1-4)-th hole including a diameter which is smaller than that of the (1-3)-th hole,
wherein (2-2)-th end plate comprises:
a (2-3)-th hole passing along the reference direction; and
a (2-4)-th hole passing along the reference direction, and a diameter of which is smaller than that of the (2-3)-th hole,
wherein the (1-3)-th hole is in communication with the (2-3)-th hole, and
wherein the (1-4)-th hole is in communication with the (2-4)-th hole.

6. The stack cartridge assembly of claim 5,
wherein the diameter of the (1-1)-th hole corresponds to the diameter of the (1-4)-th hole, and
wherein the diameter of the (1-2)-th hole corresponds to the diameter of the (1-3)-th hole.

7. The stack cartridge assembly of claim 6, wherein when a direction facing the (1-2)-th hole from the (1-1)-th hole is defined as a first direction and a direction facing the (1-3)-th hole from the (1-1)-th hole is defined as a second direction, the first direction and the second direction are perpendicular to each other.

8. The stack cartridge assembly of claim 1,
wherein a (1-1)-th fastening recess recessed along the opposite direction of the reference direction is formed at a portion of a periphery of the (1-1)-th end plate,
wherein a (1-2)-th fastening recess recessed along the reference direction is formed at a portion of a periphery of the (1-2)-th end plate, which corresponds to the (1-1)-th fastening recess, and
wherein the first stack cartridge further includes:
a first pressing member including opposite ends that are inserted into the (1-1)-th fastening recess and the (1-2)-th fastening recess to press the (1-1)-th end plate and the (1-2)-th end plate.

9. The stack cartridge assembly of claim 8,
wherein a (2-1)-th fastening recess recessed along the opposite direction of the reference direction is formed at a portion of a periphery of the (2-1)-th end plate,
wherein a (2-2)-th fastening recess recessed along the reference direction is formed at a portion of a periphery of the (2-2)-th end plate, which corresponds to the (2-1)-th fastening recess,
wherein the second stack cartridge further comprises:
a second pressing member including opposite ends of which are inserted into the (2-1)-th fastening recess and the (2-2)-th fastening recess to press the (2-1)-th end plate and the (2-2)-th end plate, and
wherein the stack cartridge assembly further comprises a connection member connecting the first pressing member and the second pressing member.

10. The stack cartridge assembly of claim 9,
wherein when, among two directions, in which the (1-1)-th fastening recess is opened, a direction other than the reference direction is defined as a protrusion direction,
wherein the first pressing member includes:
a (1-1)-th part configured to be inserted into the (1-1)-th fastening recess and having a (1-1)-th area protruding in the protrusion direction;
a (1-2)-th part configured to be inserted into the (1-2)-th fastening recess and having a (1-2)-th area protruding in the protrusion direction; and
a (1-3)-th part connecting the (1-1)-th part and the (1-2)-th part.

11. The stack cartridge assembly of claim 10,
wherein the second pressing member includes:
a (2-1)-th part configured to be inserted into the (2-1)-th fastening recess, and having a (2-1)-th area protruding in the protrusion direction;
a (2-2)-th part configured to be inserted into the (2-1)-th fastening recess, and having a (2-2)-th area protruding in the protrusion direction; and
a (2-3)-th part connecting the (2-1)-th part and the (2-2)-th part, and
wherein the (1-1)-th part and the (2-2)-th part are spaced apart from each other along the reference direction.

12. The stack cartridge assembly of claim 10, wherein a length of the (1-1)-th part along the reference direction corresponds to a length of the (1-1)-th fastening recess along the reference direction.

13. The stack cartridge assembly of claim 2, wherein the (1-2)-th end plate includes:
a fuel electrode introduction hole formed at a location corresponding to the (1-1)-th hole, the fuel electrode introduction hole including a diameter which corresponds to that of the (1-1)-th hole; and
an air electrode introduction hole formed at a location corresponding to the (1-2)-th hole, the air electrode introduction hole including a diameter which corresponds to that of the (1-2)-th hole.

14. The stack cartridge assembly of claim 2, further comprising:
a first cooling hole passing along the reference direction and disposed between the (1-1)-th hole and the (1-2)-th hole, the first cooling hole formed in the (1-1)-th end plate; and
a second cooling hole passing along the reference direction and disposed between the (2-1)-th hole and the (2-2)-th hole, the second cooling hole formed is formed in the (2-2)-th end plate.

15. The stack cartridge assembly of claim 14, further comprising:
a cooling fluid hole formed at a location correspond to the second cooling hole, the cooling fluid hole including a shape which corresponds to that of the second cooling hole,
wherein the cooling fluid hole is formed in the (2-1)-th end plate.

16. The stack cartridge assembly of claim 1, further comprising:
a third stack cartridge including a plurality of third cells stacked along the reference direction;
a (3-1)-th end plate disposed in the reference direction of the third cells; and
a (3-2)-th end plate disposed on the opposite direction of the reference direction, and disposed between the first stack cartridge and the second stack cartridge,
wherein the (1-1)-th end plate and the (3-2)-th end plate have corresponding shapes, and
wherein the (2-2)-th end plate and the (3-1)-th end plate have corresponding shapes.

17. The stack cartridge assembly of claim 1,
wherein each of the first stack cartridge and the second stack cartridge comprises a plurality of membrane electrode assemblies, and
wherein the stack cartridge assembly further comprises:
a processor configured to:
detect malfunction among the plurality of membrane electrode assemblies in at least one of the first stack cartridge and the second stack cartridge; and
upon a detection of malfunction, provide an alert of the detection to replace the stack cartridge containing the malfunctioning membrane electrode assembly.

18. A stack cartridge assembly comprising:
a first stack cartridge including:
a plurality of first cells stacked along the reference direction;
a (1-1)-th end plate disposed in a reference direction of the first cells;
a (1-2)-th end plate disposed in an opposite direction to the reference direction; and
a first pressing member configured to press the (1-1)-th end plate and the (1-2)-th end plate such that the (1-1)-th end plate and the (1-2)-th end plate press each other;
a second stack cartridge including:
a plurality of second cells stacked along the reference direction;
a (2-1)-th end plate disposed in the reference direction of the second cells;
a (2-2)-th end plate disposed in the opposite direction to the reference direction; and
a second pressing member configured to press the (2-1)-th end plate and the (2-2)-th end plate such that the (2-1)-th end plate and the (2-2)-th end plate press each other; and
a connection member connecting the first pressing member and the second pressing member.

19. The stack cartridge assembly of claim 18,
wherein each of the first stack cartridge and the second stack cartridge comprises a plurality of membrane electrode assemblies, and
wherein the stack cartridge assembly further comprises:
a processor configured to:
detect malfunction among the plurality of membrane electrode assemblies in at least one of the first stack cartridge and the second stack cartridge; and
upon a detection of malfunction, provide an alert of the detection to replace the stack cartridge containing the malfunctioning membrane electrode assembly.
